(19) United States
(12) Patent Application Publication
(10) Pub. No.: US 2022/0207120 A1
(43) Pub. Date: Jun. 30, 2022

(54) APPARATUS AND METHOD FOR EMBEDDING PLURALITY OF FORENSIC MARKS

(71) Applicant: INKA ENTWORKS, INC, Seoul (KR)

(72) Inventors: Byeong Sun PARK, Suwon-si (KR); Sang Ho PARK, Gwangju-si (KR); Sung Ju YUN, Goyang-si (KR)

(21) Appl. No.: 17/137,731

(22) Filed: Dec. 30, 2020

(51) Int. Cl. G06F 21/16

(52) U.S. Cl. CPC G06F 21/16; G06F 2221/0733

(57) ABSTRACT

Provided is an apparatus for embedding a plurality of forensic marks comprising: a pre-processing unit configured to: embed a watermark 0 symbol in each section content of an original content and store 0-section contents as a 0-content file and embed a watermark 1 symbol in each section content of the original content and store 1-section contents as a 1-content file; and embed random information in at least one section content among the 0-section contents and the 1-section contents and store random information section contents as a random information content file; and a distribution unit configured to: select corresponding section contents of the 0-content file and the 1-content file using predetermined information that is based on metadata; if a random information section content is present, select the random information section content instead of a 0-section content or a 1-section content; and output the selected random information section content as a distribution content.

### BACKGROUND OF THE INVENTION

### 1. Field of the Invention

The present disclosure relates to a method and apparatus for embedding a plurality of forensic marks. More particularly, the present disclosure relates to a method and apparatus for embedding a plurality of forensic marks, which secure a real-time response and are robust against collusion attacks.

### 2. Description of the Prior Art

A server side needs to overcome a difficulty in embedding user information in real time in order to embed a forensic mark. In order to surmount the difficulty, there is provided a method that produces a 0-content file by embedding mark 0 in an original content and a 1-content file by embedding mark 1 in the original content via a pre-processing process, and embeds a forensic mark based on user information by combining the 0-content file and the 1-content file which are produced in the pre-processing process in real time.

In this instance, if a plurality of users blend some sections of the content that the users have, the forensic mark may be easily invalidated. This may be a fatally weak point of the method. However, the method is advantageous in that the server side can embed a forensic mark in real time. Accordingly, even though the method is vulnerable to collusion attacks, the method is receiving attention from the market.

### SUMMARY OF THE INVENTION

The present disclosure has been made in order to solve the above-mentioned problems in the prior art and the object of the present disclosure is to provide a method and apparatus for embedding a plurality of forensic marks which secure a real-time response, and are robust against collusion attacks.

According to an embodiment, an apparatus for embedding a plurality of forensic marks may comprise: a pro-processing unit configured to: embed a watermark 0 symbol in each section content of an original content and store 0-section contents as a 0-content file and embed a watermark 1 symbol in each section content of the original content and store 1-section contents as a 1-content file; and embed random information in at least one section content among the 0-section contents and the 1-section contents and store random information section contents as a random information content file; and a distribution unit configured to: select corresponding section contents of the 0-content file and the 1-content file using predetermined information that is based on metadata; if a random information section content is present, select the random information section content instead of a 0-section content or a 1-section content; and output the selected random information section content as a distribution content.

The random information may be information for determining a user, and may be unique information in the original content.

The pro-processing unit may be configured to: delete a random information content file including the random information section content selected based on the predetermined information of the distribution unit; produce a new random information content file; and store the produced new random information content file.

The pre-processing unit may be configured to identify whether there are as many blocks as blocks needed for payloading the random information in a single fame.

The pre-processing unit may be configured to select only a section content having at least one intra-frame of an encoded image which includes as many blocks as blocks needed for payloading the random information, as section contents in which the random information is to be embedded.

The pro-processing unit may be configured to: select a sub-block having a size smaller than or equal to a predetermined size using encoded blocks in the intra-frame; and select a macroblock including only sub-blocks which have sizes smaller than or equal to the predetermined size, as a candidate embedding block.

The pre-processing unit may be configured to: identify whether the number of nonzero quantized coefficients (NNZ) among quantized coefficients of the candidate embedding block is greater than or equal to a predetermined number (Nt); and determine as many macroblocks as macroblocks needed for payloading the random information from a macroblock having the highest NNZ, as final embedding blocks.

The pre-processing unit may be configured to calculate a pseudo motion vector and to determine the final embedding block, in order to prevent or reduce a temporal flicker.

According to an embodiment, a method of embedding a plurality of forensic marks may comprise: embedding a watermark 0 symbol in each section content of an original content and outputting 0-section contents and embedding a watermark 1 symbol in each section content of the original content and outputting 1-section contents; embedding random information in at least one section content among the 0-section contents and the 1-section contents, and outputting random information section contents; storing the 0-section contents as a 0-content file, storing the 1-section contents as a 1-content file, and storing the random information section contents as a random information content file; and selecting corresponding section contents of the 0-content file and the 1-content file using predetermined information that is based on metadata, and if a random information section content is present, selecting the random information section content instead of a 0-section content or a 1-section content, and outputting the selected random information section content as a distribution content.

The outputting the selected random information section content as a distribution content may further comprise: deleting a random information content file including the random information section content which is selected based on the predetermined information; producing a new random information content file; and storing the produced new random information content file.

The outputting random information section contents may comprise: identifying whether there are as many blocks as blocks needed for payloading the random information in a single frame.

The outputting random information section contents may comprise: selecting only a section content having at least one intra-frame of an encoded image which includes as many blocks as blocks needed for payloading the random information, as a section content in which the random information is to be embedded.

According to the present disclosure, a forensic mark, which secures a real-time response and is robust against collusion attacks, may be provided by using both predetermined user information and random user information as forensic information.

According to the present disclosure, by storing frame information in which random information is embedded and block information of the frame, the stored information may be used for detecting a forensic mark in the future. In addition, when additional random information is embedded, the stored information may be used for embedding the random information, in the same flame and the same blocks in a fame.

### BRIEF DESCRIPTION OF THE DRAWINGS

The above and other aspects, features and advantages of the present disclosure will be mom apparent from the following detailed description taken in conjunction with the accompanying drawings, in which:

FIG. 1 is a block diagram illustrating an apparatus for embedding a plurality of forensic marks according to an embodiment of the present invention;

FIG. 2 is a diagram illustrating an example of a plurality of 0-section contents and a plurality of 1-section contents in both of which marks are embedded;

FIG. 3 is a block diagram illustrating a random information embedding unit illustrated in FIG. 1;

FIG. 4 is a diagram illustrating an example of blocks determined based on a result of analysis performed by a section analysis part of FIG. 3;

FIG. 5 is a diagram illustrating a result of an embedding process performed by a random information embedding part of FIG. 3;

FIG. 6 is a diagram illustrating an example of a random information content file stored in a random information content storage unit of FIG. 1;

FIG. 7 is a diagram illustrating an example of a distribution content outputted from a distribution unit of FIG. 1; and

FIG. 8 is a flowchart illustrating a method of embedding a plurality of forensic marks according to another embodiment of the present disclosure.

### DETAILED DESCRIPTION OF THE EXEMPLARY EMBODIMENTS

Hereinafter, a method and apparatus for embedding a plurality of forensic marks according to various embodiments will be described with reference to enclosed drawings. Hereinafter, in describing the present disclosure, terms that refer to elements of the present disclosure are named in consideration of respective functions of the elements, and thus, it should not be understood that the technical elements of the present disclosure are limited to the terms.

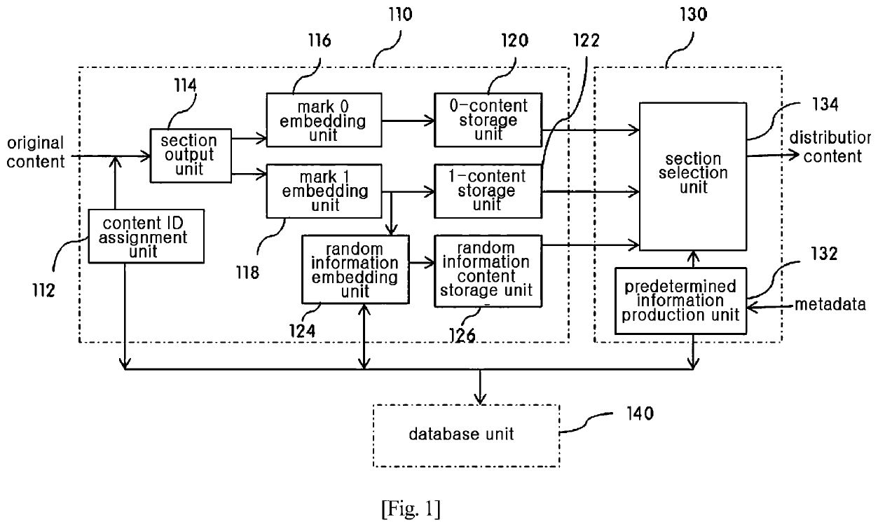

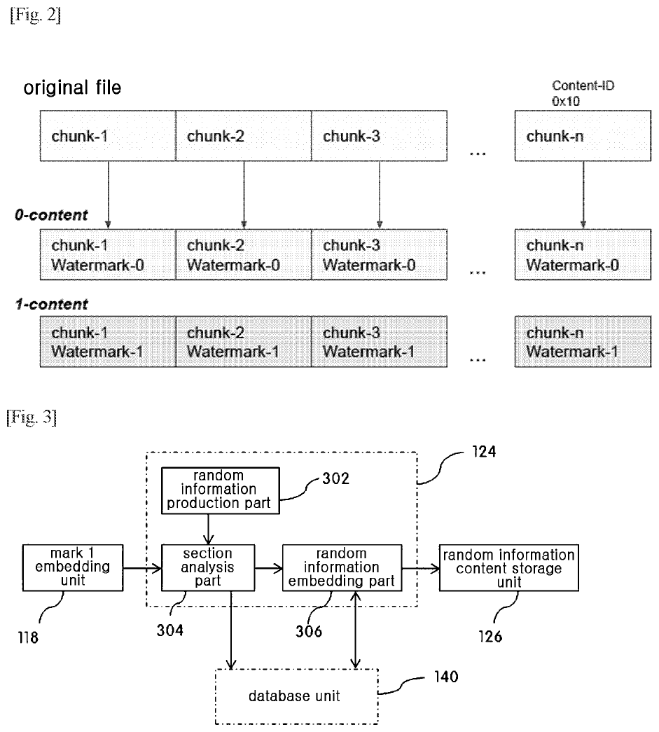

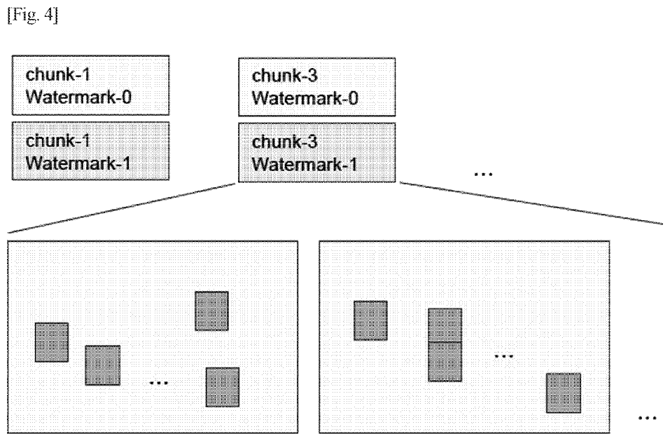

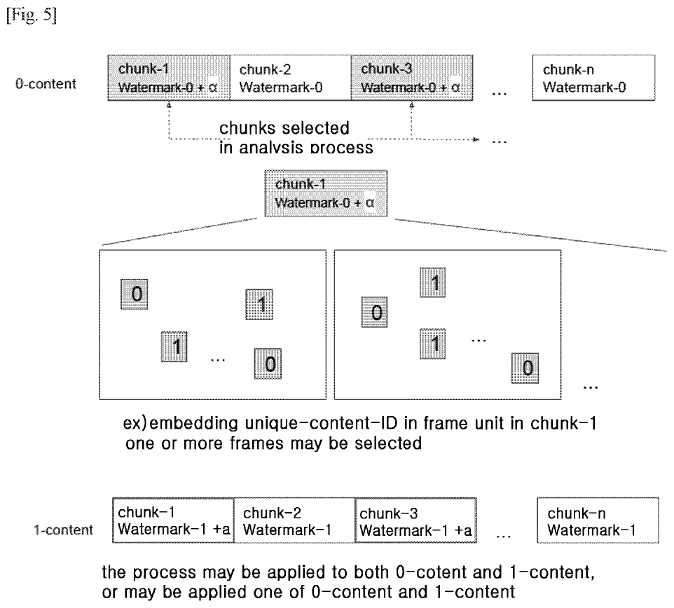

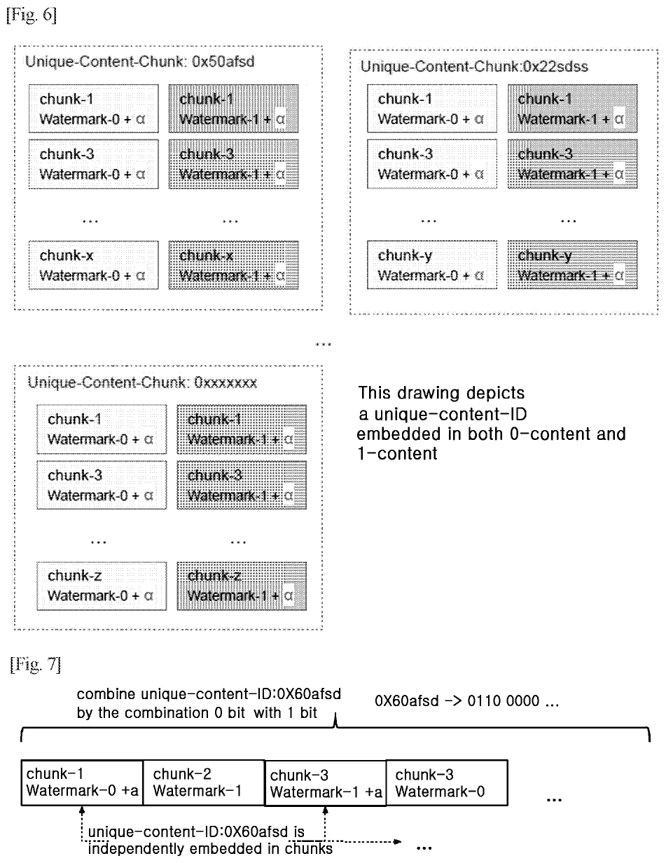

FIG. 1 is a block diagram illustrating an apparatus for embedding a plurality of forensic marks according to an embodiment of the present disclosure. FIG. 2 is a diagram illustrating an example of a plurality of 0-section contents and a plurality of I-section contents in both of which marks are embedded. FIG. 3 is a block diagram illustrating a random information embedding unit illustrated in FIG. 1. FIG. 4 is a diagram illustrating an example of blocks determined based on a result of analysis performed by a section analysis part of FIG. 3. FIG. 5 is a diagram illustrating a result of an embedding process performed by a random information embedding part of FIG. 3. FIG. 6 is a diagram illustrating an example of a random information content file stored in a random information content storage unit of FIG. 1. FIG. 7 is a diagram illustrating an example of a distribution content outputted from a distribution unit of FIG. 1.

As illustrated in FIG. 1, an apparatus for embedding a plurality of forensic marks may include a pre-processing unit 110, a distribution unit 130, and a database unit 140.

The pre-processing unit 110 may include a content ID assignment unit 112, a section output unit 114, a mark 0 embedding unit 116, a mark 1 embedding unit 118, a 0-content storage unit 120, a 1-content storage unit 122, a random information embedding unit 124, and a random information content storage unit 126.

If an original content is inputted, the content ID assignment unit 112 may assign a content ID for management to the original content. It is preferable that the content ID assignment unit 112 always assigns the same content ID if the original content is identical. However, the content ID assignment unit 112 may assign a content ID, in a series form, every time the original content is inputted into the pre-processing unit 110. The content ID assignment unit 112 may store the content ID related to the original content in the database unit 140.

The section output unit 114 may divide the original content into a predetermined size of sections, and may output section contents. Here, the predetermined size may be a predetermined period of time, for example, 2 seconds, may be a predetermined scale, for example, approximately 1M byte, or may be a unit of group of picture (GOP) of video data. The section content may be an encoded (compressed) content, or may be an unencoded (uncompressed) content. In the embodiment of the present disclosure, a chunk may be used as an example of a section.

The mark 0 embedding unit 116 may embed watermark 0 in each section content which is inputted after being outputted from the section output unit 114. The mark 1 embedding unit 118 may embed watermark 1 in each section content which is inputted after being outputted from the section output unit 114. A plurality of 0-chunk contents or a plurality of 1-chunk contents both of which are embedded the watermark 0 or the watermark 1 in chunk unit are outputted from the mark 0 embedding unit 116 or mark 1 embedding unit 118. The example thereof is illustrated in FIG. 2.

The 0-content storage unit 120 may store a plurality of 0-section contents outputted from the mark 0 embedding unit 116, as a 0-content file. The 1-content storage unit 122 may store a plurality of 1-section contents outputted from the mark 1 embedding unit 118, as a 1-content file. The 0-content file stored in the 0-content storage unit 120 and the 1-content file stored in the 1-content storage unit 122 may be used by the distribution unit 130, and may be provided to the random information embedding unit 124 if the embedding of random information is further required.

The random information embedding unit 124 may produce random information section content by embedding random information in some sections of the 0-content file outputted from the mark 0 embedding unit 116 and/or some sections of the 1-content file outputted from the mark 1 embedding unit 118. Here, the random information (unique-content-ID) is random user information, and is unique information in a content ID. Although the random information embedding unit 124 is illustrated in association with only a 1-chunk content outputted from the mark 1 embedding unit 118 in FIG. 1, the random information embedding unit 124 may also be used for a 0-chunk content outputted from the mark 0 embedding unit 116.

As illustrated in FIG. 3, the random information embedding unit 124 may include a random information production part 302, a section analysis part 304, and a random information embedding part 306, in order to embed random information in some chunks of the 0-content file or the 1-content file.

The random information production part 302 may produce random information to be embedded in some chunks of the 0-content file or the 1-content file. Here, if a content ID is 0X10, and unique values are 50afsd, 22sdss, or xxxxxx, respectively, random information may be 0x10-50afsd, 0x10-22sdss, or 0x10-xxxxxx.

The section analysis part 304 may analyze blocks of an intra-fame, in order to select at least one frame in which a mark of random information is to be embedded in a single chunk. Particularly, the section analysis part 304 may select the best chunk which is capable of expressing an intact random information watermark, when receiving, as input, a 1-chunk content in which watermark 1 is embedded, and may analyze and select a block that is capable of expressing a payload in a frame in the case of video data.

The section analysis part 304 may select a block having a size less than or equal to a predetermined size in an intra-frame of an encoded image, that is, a block which is encoded to be the smallest block size. The section analysis part 304 may select, for example, a luminance signal of 4×4 prediction blocks from an intra-frame. Accordingly, a block that is encoded to be a block size greater than the predetermined size in the intra-frame may be excluded from a group of block candidates in which random information is to be embedded. The reason of excluding blocks encoded to be a block size greater than the predetermined size is that since the image of these blocks is close to a smooth image, if a watermark is embedded in the blocks, the watermark has a high probability of being exposed outside. For example, if blocks are encoded to be any one of 32×32 blocks, 32×16 blocks, 16×32 blocks, and 16×16 blocks in the HEVC standard, the blocks may be considered to be a smooth image. And if blocks are encoded to be any one of 16×16 blocks, 8×16 blocks, and 16×8 blocks in the AVC standard, the block may be considered to be a smooth image.

The section analysis part 304 may select a macroblock configured with only blocks having sizes less than or equal to a predetermined size. The section analysis part 304 may select, for example, in the case of the AVC standard, a 16×16 macroblock configured with only 4×4 sub-blocks selected from an intra-frame of an encoded image.

The section analysis part 304 may identify whether the number of nonzero quantized coefficients (NNZ) among quantized coefficients of the selected macroblock, is greater than a predetermined number (Nt). If the number of NNZs is greater than the predetermined number (Nt), the section analysis part 304 may select the corresponding block as a block in which random information is capable of being embedded. If the number of NNZs is less than the predetermined number (Nt), a large portion of the original information of the corresponding macroblock may be lost during an image decoding process and, as a result of it, a synchronization error may highly occur. Accordingly, the predetermined number (Nt) needs to be set in consideration of the above-described facts.

If a frame has the number of macroblocks in which random information is capable of being embedded which is greater than or equal to the predetermined number of macroblocks needed for payloading the random information, for example, greater than or equal to 64 macroblocks, the section analysis part 304 may select the frame as a frame in which the random information is to be embedded. If the number of macroblocks to be used for the payload of the random information is greater than or equal to the predetermined number, the section analysis part 304 may determine 64 macroblocks from a macroblock having the highest NNZ as final macroblocks in which the random information is to be embedded. An example of blocks determined based on the result of analysis performed by the section analysis part 304 is illustrated in FIG. 4.

A temporal flicker may occur in an image in which a watermark of random information is inserted. The section analysis part 304 may calculate a pseudo motion vector to determine a final macroblock in which random information is to be embedded, in order to prevent or reduce the temporal flicker.

If the final macroblock in which the random information is to be embedded is determined, the section analysis part 304 may store frame information and location information of blocks in the fame, in the database unit 140.

The random information embedding part 306 may embed random information produced by the random information production part 302 in each of a plurality of frames selected by the section analysis part 304, so as to produce random information chunk content. The random information embedding part 306 must embed the same random information in every chunk selected by the section analysis part 304, so that a user is determined based on the random information. For example, the same information is inserted into all the chunks selected in the section analysis part 304, which is random information 0x10-50afsd generated in the random information generation part 302. After the random information embedding part 306 embeds the random information, all chunks outputted from the random information embedding part 306 may have not only watermark, but also random information (unique-content-ID), which is intact itself. A result of the embedding process performed by the random information embedding part 306 is illustrated in FIG. 5. Although FIG. 5 illustrates only four blocks as shown in FIG. 4, the number of blocks may be the number of blocks needed for displaying all of the payloads of random information 0x10-50afsd, for example, 64 blocks. The random information embedding part 306 may store the random information in the database unit 140.

The random information content storage unit 126 may store random information chunk content, in which random information is embedded by the random information embedding unit 124, as a single random information content file. An example of the random information content file stored in the random information content storage unit 126 is illustrated in FIG. 6. Preferably, the random information content storage unit 126 may store as many random information content files, in which random information is embedded in advance, as a chunk pool can manage.

The distribution unit 130 may include a predetermined information production unit 132 and a section selection unit 134, in order to select corresponding section contents from a 0-content file or a 1-content file based on predetermined information and output the selected section contents.

The predetermined information production unit 132 produces predetermined information using metadata received from a user device or the like. Here, the metadata may be user information, time information (date/time), or the like. Here, the user information may include ID information of a user, or user device information. The user device information may be information associated with the unique ID (e.g., IP address or MAC address information) of a user device, and the time information may be transmitted using, for example, a time information protocol (NTP, Network Time Protocol, RFC-1305) or the like from a time server on a network.

If the predetermined information is produced, the predetermined information production unit 132 may provide the predetermined information to the section selection unit 134, and may store the predetermined information in the database unit 140 by connecting the same to the user information.

The section selection unit 134 may select corresponding section contents from the 0-content file or 1-content file based on the predetermined information inputted after being outputted from the predetermined information production unit 132, and may output the selected section contents. If the 0-section content or the 1-section content corresponds to a section including random information, the section selection unit 134 may select and output the corresponding random information section content from the random information content storage unit 126. Accordingly, the distribution unit 130 may transmit to a user device or the like a distribution content in which the random information is embedded in addition to the predetermined information which may specify a user. An example of the distribution content outputted from the distribution unit 130 is illustrated in FIG. 7.

The random information content file which is transmitted together with the predetermined information by the distribution unit 130 may be removed from the random information content storage unit 126. If the number of random information content files that remain in the chunk pool of the random information content storage unit 126 is less than a predetermined number, the pre-processing unit 110 may operate the random information embedding unit 124 so as to produce a random information content file, and may store the produced random information content file into the random information content storage unit. In this case, the random information may be embedded using frame information and location information of a macroblock stored in the database unit 140.

The database unit 140 may store a content ID assigned from the content ID assignment unit 112, and may store random information embedded by the random information embedding part 306. The random information may be stored by being connected to the predetermined information together with metadata inputted by the distribution unit 130. Accordingly, a distribution content distributed to a user device or the like may include not only predetermined information associated with selection of a section, but also random information included in a random information section content, so that it may be robust against collusion attacks.

The database unit 140 may store frame information associated with a frame in which random information is embedded and location information of the blocks in the frame by connecting the same to the content ID. Accordingly, the information may be used when detecting a forensic mark in the future. In addition, this information may be used to select a frame or a block within the frame in which a watermark is to be inserted when the watermark is embedded by the random information embedding unit (124).

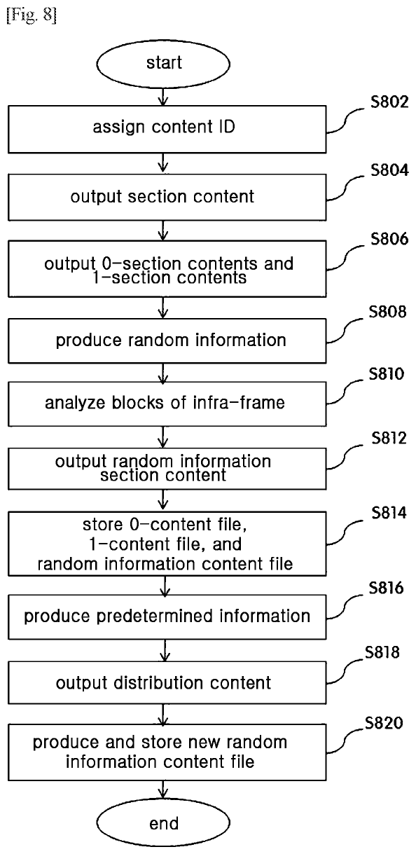

FIG. 8 is a flowchart illustrating a method of embedding a plurality of forensic marks according to another embodiment of the present disclosure.

If an original content is inputted, the content ID assignment unit 112 assigns a content ID to the original content for management (S802). The section output unit 114 divides the original content into a predetermined size of sections, and then outputs section contents (S804). The section content outputted from the section output unit 114 may be an encoded (compressed) content or an unencoded (uncompressed) content.

The mark 0 embedding unit 116 embeds a watermark 0 symbol in each section content which is inputted after being outputted from the section output unit 114, and then outputs 0-section contents. The mark 1 embedding unit 118 embeds a watermark 1 symbol in each section content which is inputted after being outputted from the section output unit 114, and then outputs 1-section contents (S806).

The random information production part 302 produces random information to be embedded in some chunks of the 0 or 1 content file (S808). Here, if a content ID is 0X10, and unique values are 50afsd, 22sdss, or xxcor, respectively, then random information may be produced to be 0x10-50afsd, 0x10-22sdss, or 0x10-xxxxxx.

The section analysis part 304 analyzes the blocks of an intra-frame, in order to select at least one frame in which the watermark of the random information is to be embedded in a single section (S810). Particularly, the section analysis part 304 may select the best section which is capable of expressing an intact random information watermark when receiving, as input, a 1-chunk content in which watermark 1 is embedded, and may analyze and select a block that is capable of expressing a payload in a frame in the case of video data.

The random information embedding part 306 embeds random information produced by the random information production part 302 in each of a plurality of frames selected by the section analysis part 304, and then outputs random information section content (S812).

The 0-content storage unit 120 may store a plurality of 0-section contents outputted from the mark-0 embedding unit 116 as a 0-content file, the 1-content storage unit 122 may store a plurality of 1-section contents outputted from the mark-1 embedding unit 118 as a 1-content file, and the random information content storage unit 126 may store random information section contents in which random information is embedded by the random information embedding unit 124, as a single random information content file (S814).

The predetermined information production unit 132 produces predetermined information using metadata received from a user device or the like (S816). Here, the metadata may be user information, time information (date/time), or the like.

The section selection unit 134 selects corresponding section contents from the 0-content file or the 1-content file based on the predetermined information inputted after being outputted from the predetermined information production unit 132, and if a random information section content is present, the section selection unit 134 selects the random information section content instead of a 0-section content or a 1-section content, and outputs a distribution content (S818).

The pre-processing unit deletes a random information content file that includes the random information section content selected based on the predetermined information that is inputted after being outputted from the predetermined information production unit 132, and produces and stores a new random information content file (S820).

Although blocks are described to be selected based on analysis in the above embodiment of the present disclosure, fixed blocks may be selected and used depending on the case.

The above-described embodiment of the present disclosure merely illustrates the technical idea of the present disclosure, and the scope of the present disclosure should be construed based on the claims provided below. In addition, it would be apparent that those skilled in the art would make various modifications and changes without departing from the scope of the subject matter of the present disclosure, and thus, all technical ideas falling within the scope equivalent to the scope of the present disclosure should be construed as being in the scope of the right of the present disclosure.

1. An apparatus for embedding a plurality of forensic marks, the apparatus comprising:
a pre-processing unit configured to: embed a watermark 0 symbol in each section content of an original content and store 0-section contents as a 0-content file and embed a watermark 1 symbol in each section content of the original content and store 1-section contents as a 1-content file; and embed random information in at least one section content among the 0-section contents and the 1-section contents and store random information section contents as a random information content file; and
a distribution unit configured to: select corresponding section contents of the 0-content file and the 1-content file using predetermined information that is based on metadata; if a random information section content is present, select the random information section content instead of a 0-section content or a 1-section content; and output the selected random information section content as a distribution content.

2. The apparatus of claim 1, wherein the random information is information for determining a user, and is unique information in the original content.

3. The apparatus of claim 2, wherein the pre-processing unit is configured to: delete a random information content file including the random information section content selected based on the predetermined information of the distribution unit; produce a new random information content file; and store the produced new random information content file.

4. The apparatus of claim 1, wherein the pre-processing unit is configured to identify whether there are as many blocks as blocks needed for payloading the random information in a single frame.

5. The apparatus of claim 4, wherein the pre-processing unit is configured to select only a section content having at least one intra-frame of an encoded image which includes as many blocks as blocks needed for payloading the random information, as section contents in which the random information is to be embedded.

6. The apparatus of claim 5, wherein the pre-processing unit is configured to: select a sub-block having a size smaller than or equal to a predetermined size using encoded blocks in the intra-frame; and select a macroblock including only sub-blocks which have sizes smaller than or equal to the predetermined size, as a candidate embedding block.

7. The apparatus of claim 6, wherein the pre-processing unit is configured to: identify whether the number of nonzero quantized coefficients (NNZ) among quantized coefficients of the candidate embedding block is greater than or equal to a predetermined number (Nt); and determine as many macroblocks as macroblocks needed for payloading the random information from a macroblock having the highest NNZ, as final embedding blocks.

8. The apparatus of claim 7, wherein the pre-processing unit is configured to calculate a pseudo motion vector and to determine the final embedding block, in order to prevent or reduce a temporal flicker.

9. A method of embedding a plurality of forensic marks, the method comprising:
embedding a watermark 0 symbol in each section content of an original content and outputting 0-section contents and embedding a watermark 1 symbol in each section content of the original content and outputting 1-section contents;
embedding random information in at least one section content among the 0-section contents and the 1-section contents, and outputting random information section contents;
storing the 0-section contents as a 0-content file, storing the 1-section contents as a 1-content file, and storing the random information section contents as a random information content file; and
selecting corresponding section contents of the 0-content file and the 1-content file using predetermined information that is based on metadata, and if a random information section content is present, selecting the random information section content instead of a 0-section content or a 1-section content, and outputting the selected random information section content as a distribution content.

10. The method of claim 9, wherein the outputting the selected random information section content as a distribution content further comprises:
deleting a random information content file including the random information section content which is selected based on the predetermined information;
producing a new random information content file; and
storing the produced new random information content file.

11. The method of claim 9, wherein the outputting random information section contents comprises:
identifying whether there are as many blocks as blocks needed for payloading the random information in a single frame.

12. The method of claim 11, wherein the outputting random information section contents comprises:
selecting only a section content having at least one intra-frame of an encoded image which includes as many blocks as blocks needed for payloading the random information, as a section content in which the random information is to be embedded.
